(19) United States
(12) Patent Application Publication
(10) Pub. No.: US 2020/0211356 A1
(43) Pub. Date: Jul. 2, 2020

(54) Boiling detection and alert system and method for cooking applications

(71) Applicant: Eric Sporer, Tacoma, WA (US)

(72) Inventor: Eric Sporer, Tacoma, WA (US)

(21) Appl. No.: 16/237,805

(22) Filed: Jan. 2, 2019

(51) Int. Cl. G08B 21/18; G01P 15/08; G01H 1/00

(52) U.S. Cl. CPC G08B 21/182; G01H 1/00; G01P 15/0802

(57) ABSTRACT

A boiling detection and alert system and method for cooking applications. The system includes a vibration sensor assembly to be coupled to a piece of cookware to detect the boiling condition of the cookware. The system alerts a remote operator of changes in boiling condition so that the operator may leave the vicinity of the cookware and not miss the onset of boiling or forget about the cookware that has boiled dry. The method includes steps for detecting the boiling state of cookware and alerting a remote operator of changes in the boiling state.

### BACKGROUND OF THE INVENTION

Cooking processes involving liquids often requiring boiling steps. Applying enough heat to cookware to create a boiling condition often takes a substantial amount of time. Cooking operations, such as stirring or reducing heat are often performed at the start of a boiling condition and operators often remain in close proximity to cookware to detect visual or auditory indications of a boiling condition. Operators who leave their kitchen often may not be present for the onset of boiling, causing food to stick to cookware or liquid to boil over. Furthermore, once a boiling condition is reached, boiling steps can often last for hours. Operators often forget about boiling liquids in their cookware, which can burn food, destroy cookware and even lead to fires. Operators often set kitchen timers so that they can prevent cooking without liquid after a boiling condition, however sometimes operators forget to set these timers, or forget that timers are set and leave the audible range of the timer.

### BRIEF SUMMARY OF THE INVENTION

One aspect of the disclosure is to provide a standalone vibration sensor assembly in a housing adapted to attach to a piece of cookware, in which the vibration sensor assembly determines the boiling state of the cookware based on vibrations and transmits this information to an operator wirelessly. A further aspect of the disclosure is to alert the operator when the boiling state has changed. A further aspect of the disclosure is to provide a method for alerting remote operators of changes in the boiling state of cookware.

### BRIEF DESCRIPTION OF THE DRAWINGS

FIG. 1 is a side view of a boiling detection and alert system for cooking applications coupled to the handle of a piece of cookware as per one embodiment of the invention described herein.

FIG. 2 is a schematic of a boiling detection method for cooking applications

FIG. 3A is a schematic of the signal processing performed in one embodiment, whereby acceleration data is used as a boiling indicator.

FIG. 3B is a schematic of the signal processing performed in one embodiment, whereby acceleration data is integrated into velocity data and velocity data is used as a boiling indicator.

### DETAILED DESCRIPTION OF THE INVENTION

Cooking processes involving liquids often requiring boiling. Applying enough heat to cookware to create boil a liquid often takes a substantial amount of time. Cooking operations, such as stirring or reducing heat are often performed as soon as a boiling begins and operators often remain in close proximity to cookware to detect when boiling begins. Operators who leave their kitchen often may not be present for the onset of boiling, causing food to stick to cookware or liquid to boil over.

Boiling steps can often last for hours. Operators often forget about boiling liquids in their cookware, which can burn food, destroy cookware and even lead to fires should an operator leave their home. Operators often set kitchen timers so that they do not forget about boiling liquids, however sometimes operators forget to set these timers, or forget that timers are set and leave the audible range of the timer.

The invention described herein is a system including a standalone vibration sensor assembly in a housing adapted to attach to a piece of cookware, in which the vibration sensor assembly determines the boiling state of the cookware based on vibrations and transmits this information to an operator wirelessly. A further aspect of the disclosure is to alert the operator when boiling status has changed. This functionality prevents an operator from missing the onset of boiling and forgetting about boiling liquids.

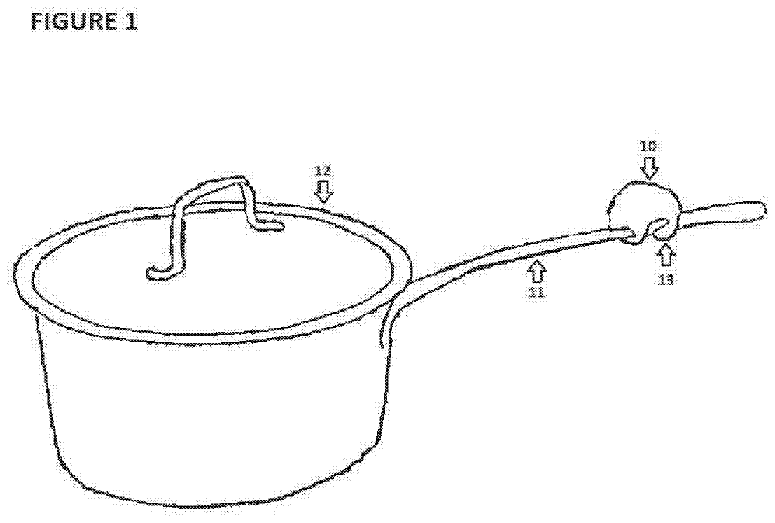

FIG. 1 depicts one embodiment of a boiling detection and alert system for cooking applications in its intended use. In this embodiment, vibration sensor assembly 10 is mounted to a handle 11 of a pot 12, filled with a liquid. Vibration sensor assembly 10 may contain an accelerometer or any other suitable vibration detecting device, which, through contact, can detect vibration or lack of vibration of pot 11. A housing 13 of vibration sensor assembly 10 is shown in this embodiment to be adjustable to mount the various pieces and types of cookware while maintaining contact. Mounting to handle 11 of the pot 12 is advantageous in that handles are generally the coolest part of the cookware, both removed from heat sources and often insulated. This acts to protect vibration sensor assembly 10 from the high heats associated with boiling cookware. Housing 13 of vibration sensor assembly 10 may preferably, in one embodiment of the invention, be of silicone or other insulating material to allow for flexible mounting while protecting the electrical components of vibration sensor assembly 10 from heat. Mounting vibration sensor assembly 10 to handle 11 of pot 12 also moves vibration sensor assembly 10 as far as possible from the bulk material of pot 12, which may be steel or another material which could inhibit wireless communication with external devices. Not shown in FIG. 1 are the internal components which allow for the operation of the device, which in some embodiments may include an accelerometer or other vibration transducer, a battery, a microprocessor, a Bluetooth communications module, a power button and other accessory devices.

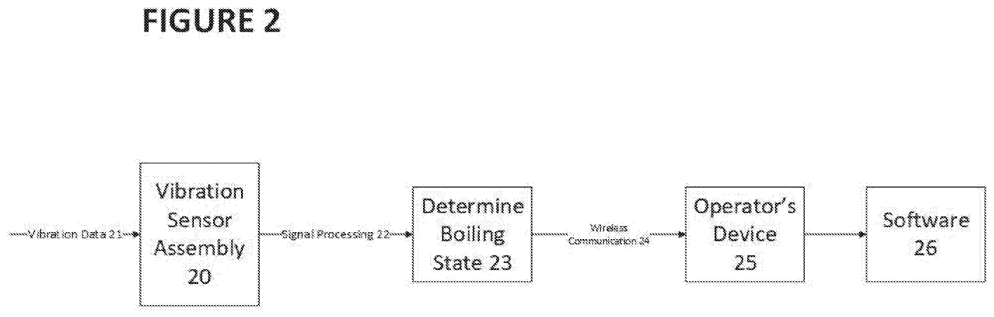

FIG. 2 depicts a schematic view of one embodiment of a boiling detection and alert method for cooking applications. The vibration sensor assembly 20 collects vibration data 21 and uses signal processing 22 to determine a boiling state 23. This boiling state 23 can be relayed to an operator using wireless communication 24. This wireless communication 24 may be made directly to a user. In one embodiment of the invention, the wireless communication 24 is made directly via Bluetooth communication. This wireless communication 24 may also be made indirectly. In one embodiment of the invention, the wireless communication 24 is made indirectly, whereby the vibration sensor assembly 20 communicates with a server via a wireless router and the operator receives the boiling state 23 from the server. The operator may be receiving the boiling state 23 on any suitable device 25 adapted to receive the information wirelessly, including but not limited to a cellular phone, a tablet or a computer.

In an exemplary embodiment of the invention, the boiling detection and alert system for cooking applications includes software 26 installed on device 25. This software may be adapted to alert an operator when the boiling state 23 has changed. This alert allows the boiling detection system to alert a user when a piece of cookware has begun boiling or has boiled dry. This software may also be adapted to alert an operator when communication has been lost, for instance when an operator has had a Bluetooth connection with vibration sensor assembly 20 severed, which may be due to leaving the range of the connection. This functionality allows this embodiment of the invention to prevent an operator from leaving the site where they were cooking and forgetting about their boiling cookware. In one more embodiment of the invention, the software may include timers which can be set within the software and started either manually or triggered by a change in boiling state. This allows the operator to be alerted after a piece of cookware has been boiling for a set length of time, which is often desirable when performing cooking operations.

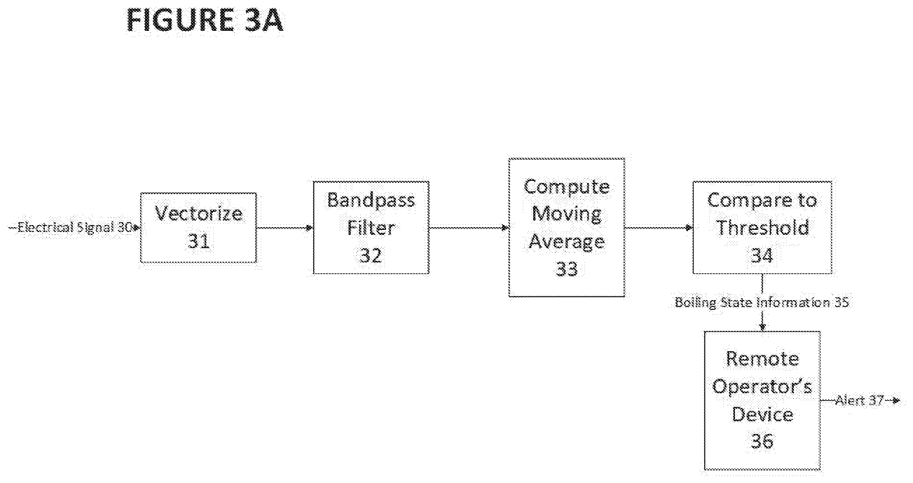

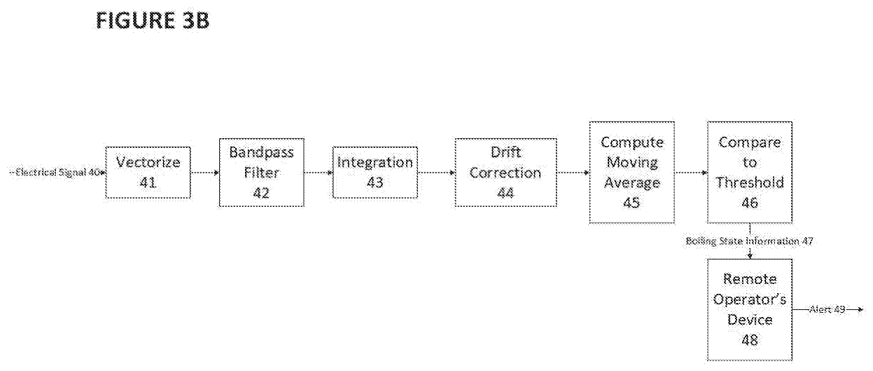

FIG. 3A depicts one example of signal processing performed in one embodiment of a boiling detection and alert system for cooking applications. In this embodiment of the invention, the first step of the signal processing is to receive electrical signal(s) 30, which may, in one embodiment of the invention, be an acceleration signal produced by an accelerometer. The second step of the signal processing is to vectorize 31 the signal to obtain a magnitude of the signal. For multi-axial or multi-component signals, these signals may then be summed to create a single magnitude vector. A bandpass filter 32 is then applied to the signal, to filter out data in frequency bands known not to represent boiling related vibration. A moving average 33 is then computed to provide signal compression and remove any data irregularities. This moving average 33 is then compared to a threshold value 34 in order to make a boiling state determination. This signal processing system can then transmit boiling state information 35 wirelessly to a remote operator's device 36, which can receive the information 35 and create an alert 37 of changes in boiling state.

FIG. 3B depicts one example of signal processing performed in a similar embodiment to that of FIG. 3A. In this embodiment of the invention, the first step of the signal processing is to receive electrical signal(s) 40, which may, in one embodiment of the invention, be an acceleration signal produced by an accelerometer. The second step of the signal processing is to vectorize 41 the signal to obtain a magnitude of the signal. For multi-axial or multi-component signals, these signals may then be summed to create a single magnitude vector. A bandpass filter 42 is then applied to the signal, to filter out data in frequency bands known not to represent boiling related vibration. The data is then integrated 43, which may, in one embodiment of the invention, convert acceleration data into velocity data. This data may then receive a drift correction 44 to correct drift due to signal error or numerical integration. A moving average 45 is then computed to provide signal compression and remove any data irregularities. This moving average 45 is then compared to a threshold value 46 in order to make a boiling state determination. This signal processing system can then transmit boiling state information 47 wirelessly to a remote operator's device, which can receive the information 48 and create an alert 49 of changes in boiling state.

One key aspect of the invention, which is critical to the inventive concept, is that the sensor system is not integrated to the appliance. This aspect allows it to be used in conjunction with existing cookware and appliances, obviating the need to replace existing cooking equipment. The system can be used by gas, conventional electric and induction cookware in conventional kitchen settings as well as alternative settings, such as outdoors.

Another key inventive aspect is a simplistic amplitude based signal processing schema, which is low on resources and accounts for signal drift. This low resource, high accuracy signal processing is critical for the long term operation of a standalone device that in one embodiment, may run off of battery power.

Another key inventive aspect is the method of alerting a remote operator using a wireless communications system, which can alert an operator of boiling conditions via various wireless communication protocols. This aspect of the invention is critical in the invention and its functionality and differentiates it from previous inventions in that it alerts users who have left the vicinity and would not be alerted by an audible alarm attached to the cookware. The system also simply alerts the operator and does not provide any unwanted input, differentiating the invention described herein with any other system that may contain an interlock or other automated cooking control in which a false positive could potentially ruin the food being cooked.

It is to be understood that this disclosure describes only a preferred embodiment of the invention as presently described and system and physical design and functionality of the parts comprising the system are by no means limited by this disclosure. The system described herein could be used in any other applications which could benefit from remote alerts of changes in vibration data, such as industrial applications.

I claim:

1. A vibration sensor assembly consisting of one or more accelerometers, configured to generate an electrical signal that corresponds to accelerations of a piece of cookware; a processor arranged to receive the electrical signal and determine each of a boiling condition and a boil-dry condition for a liquid contained within the cookware, wherein the determination is based on a comparison of the electrical signal and an acceleration amplitude threshold, and wherein the vibration sensor assembly is physically mounted in an enclosure that is a standalone unit adapted to be mounted either directly to the cookware, to its handle or its lid, wherein the enclosure is non-integral with the cookware, lid and handle.

2. The vibration sensor assembly of claim 1, wherein the determination is based on a comparison of a computed average of the acceleration data over a preset length of time to the acceleration threshold.

3. The vibration sensor assembly of claim 1, wherein a bandpass filter is applied to the acceleration data.

4. The vibration sensor assembly of claim 1, wherein the enclosure is made of silicone rubber or other heatproof material and contains an adjustable mounting mechanism to mount to various pieces of cookware.

5. The vibration sensor assembly of claim 1, wherein the processors applies a drift correction to the electrical signal.

6. The vibration sensor assembly of claim 1, wherein the processor is coupled to a wireless communication module.

7. The vibration sensor assembly of claim 6, wherein the wireless communication module is wirelessly coupled to a secondary electrical device, wherein the secondary electrical device is adapted to alert a person at a remote location of a boiling or boil-dry condition.

8. A vibration sensor assembly, comprising one or more accelerometers, configured to generate an electrical signal that corresponds to accelerations of a piece of cookware; a processor arranged to receive the electrical signal and determine each of a boiling condition and a boil-dry condition for a liquid contained within the cookware, wherein the determination is based on a conversion of the electrical signal into velocity data by integrating the electrical signal and a comparison of the velocity signal to a velocity amplitude threshold, and wherein the vibration sensor assembly is physically mounted in an enclosure that is a standalone unit adapted to be mounted either directly to the cookware, to its handle or its lid, wherein the enclosure is non-integral with the cookware, lid and handle.

9. The vibration sensor assembly of claim 8, wherein the determination is based on a comparison of a computed average of velocity data over a preset length of time to the velocity threshold.

10. The vibration sensor assembly of claim 8, wherein a drift correction is applied to the velocity data to prevent false readings.

11. The vibration sensor assembly of claim 8, wherein a bandpass filter is applied to the velocity data.

12. The vibration sensor assembly of claim 8, wherein the vibration sensor assembly is physically mounted in an enclosure, whereby the enclosure is adapted to be mounted either directly to the cookware, to its handle or its lid.

13. The vibration sensor assembly of claim 8, wherein the processors applies a drift correction to one of electrical signal or the velocity signal.

14. The vibration sensor assembly of claim 8, wherein the processor is coupled to a wireless communication module.

15. The vibration sensor assembly of claim 13, wherein the wireless communication module is wirelessly coupled to a secondary electrical device, wherein the secondary electrical device is adapted to alert a person at a remote location of a boiling or boil-dry condition.

16. A method for alerting a user of the boiling state cookware, comprising generating an electrical signal in response to the vibrations of the cookware, comparing the amplitude of the electrical signal to an amplitude threshold to make a boil or boil-dry determination, sending an alert via wireless communication to the user when the boil or boil-dry determination changes.
